(19) United States
(12) Patent Application Publication
(10) Pub. No.: US 2015/0047992 A1
(43) Pub. Date: Feb. 19, 2015

(54) AMMONIA DOSING CARTRIDGE AND METHOD

(71) Applicant: International Engine Intellectual Property Company LLC, Lisle, IL (US)

(72) Inventors: George D. Boyd, New Palestine, IN (US); Ramon A. Mella, Greenfield, IN (US); Donald Brent Odom, Alexandria, IN (US)

(73) Assignee: International Engine Intellectual Property Company, LLC, Lisle, IL (US)

(21) Appl. No.: 13/636,791

(22) PCT Filed: Mar. 24, 2011
(86) PCT No.: PCT/US11/29698

§ 371 Date: Sep. 24, 2012

Related U.S. Application Data
(60) Provisional application No. 61/318,657, filed on Mar. 29, 2010.
(60) Provisional application No. 61/355,397, filed on Jun. 16, 2010.

(51) Int. Cl. F17C 11/00; F17C 5/06; F01N 3/08; F17C 1/00

(52) U.S. Cl. CPC F17C 11/00; F17C 1/00; F17C 5/06; F01N 3/08
USPC 206/7; 53/403

(57) ABSTRACT

A device and method for storage and delivery of ammonia for use on a vehicle, is disclosed. The device includes a sealable container, a predetermined amount of a solid ammonia-containing material, wherein the container is filled with the ammonia-containing material prior to sealing, and a canister for receiving the filled, sealed containers. The method includes loading the canister by stacking a plurality of the filled, sealed containers one on top of the other within the canister, and subsequently compressing and crushing the containers to release the ammonia gas for use in the reduction of NOₓ in a vehicle exhaust system.

### TECHNICAL FIELD OF THE INVENTION

The present device and method relate to the storage and delivery of ammonia. Particularly, the device and method relate to storage of ammonia in a solid form and subsequent release of gaseous ammonia for use on a vehicle in the selective catalytic reduction of NOₓ.

### BACKGROUND OF THE INVENTION

Compression ignition engines provide advantages in fuel economy, but produce both NO and particulates during normal operation. New and existing regulations continually challenge manufacturers to achieve good fuel economy and reduce the particulates and NOₓ emissions. Lean-burn engines achieve the fuel economy objective, but the high concentrations of oxygen in the exhaust of these engines yields significantly high concentrations of NOₓ as well. Accordingly, the use of NOₓ reducing exhaust treatment schemes are being employed in a growing number of systems.

One such system is the direct addition of ammonia gas to the exhaust stream. Transporting ammonia as a pressurized liquid, however, can be hazardous if the container bursts caused by an accident or if a valve or tube breaks. In the case of using a solid storage medium, the safety issues are much less critical since a small amount of heat is required to release the ammonia and the equilibrium pressure at room temperature can be—if a proper solid material is chosen—well below 1 bar. Previous designs for delivery of solid ammonia, such as ammonia saturated strontium chloride, included wrapping the material into aluminum foil balls. The balls are then placed in a canister where they are pressed under a load of up to 300 tons to reach a density of approximately 1.2 g/cc. However, the machines typically required to fill and wrap the foil balls needs to be at very high speed (6 parts per second) in order to achieve the necessary rate for high volume. In addition, such machines tend to be expensive and difficult to maintain. Finally, it can be difficult to load the balls into the machine without damaging them, in that the wrapping can become unsealed, loose and subject to leakage. Therefore, conveying the foil balls at the speed required to meet the desired volume would likely be difficult to do without damaging them.

It is an advantage to deliver ammonia directly in the form of a gas, both for simplicity of the flow control system and for efficient mixing of reducing agent, ammonia, with the exhaust gas. The direct use of ammonia also eliminates potential difficulties related to blocking of the dosing system, which are cause by precipitation or impurities, e.g., in a liquid-based urea solution. In addition, an aqueous urea solution cannot be dosed at a low engine load since the temperature of the exhaust line would be too low for complete conversion of urea to ammonia (an CO₂).

Therefore, the present device and method relate to providing ammonia in solid form for the purpose of ammonia storage, transport and delivery for use in stationary and mobile applications, such as catalytic removal of NOₓ, i.e., selective catalytic reduction using ammonia.

### SUMMARY OF THE INVENTION

There is disclosed herein a device and method, each of which avoids the disadvantages of prior devices and methods while affording additional structural and operating advantages.

Generally speaking, a device and method for storage and delivery of ammonia for use in connection with NOₓ reduction in the exhaust system of a vehicle, is disclosed. In one embodiment of the device for storage and delivery of ammonia, the device includes a pre-formed, sealable container and a predetermined amount of solid ammonia-containing material, wherein the container is filled with the ammonia-containing material prior to sealing.

In another embodiment, the device includes a pre-formed, sealable container, a predetermined amount of ammonia-containing material, wherein the container is filled with the ammonia-containing material prior to sealing, and a canister for receiving the filled, sealed containers. The container comprises a compactable material, for stacking and compressing the filled, sealed containers within the canister for a desired amount of the ammonia-containing material.

In the disclosed method, an embodiment for the method of storage and delivery of ammonia includes the steps of providing a pre-formed container having a top edge and a flat bottom, and a cover for sealing the top edge of the container. The method also includes providing a predetermined amount of ammonia-containing material, filling the container with the predetermined amount of the ammonia-containing material, and sealing the top edge of the container after filling with the ammonia-delivery material, thereby forming a stackable container.

In another embodiment, the method further comprises the steps of compressing the stacked containers within the canister, and subsequently crushing the filled containers within the canister for subsequent release of the ammonia.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of the ammonia-delivery material storage device of the present invention.

FIG. 2 is a cut-away view of a canister loaded with the delivery and storage device prior to compression of the device.

FIG. 3 is a cut-away view of a canister loaded with the delivery and storage device under compression.

FIG. 4 is a perspective view of the present device in use.

### DETAILED DESCRIPTION OF THE INVENTION

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

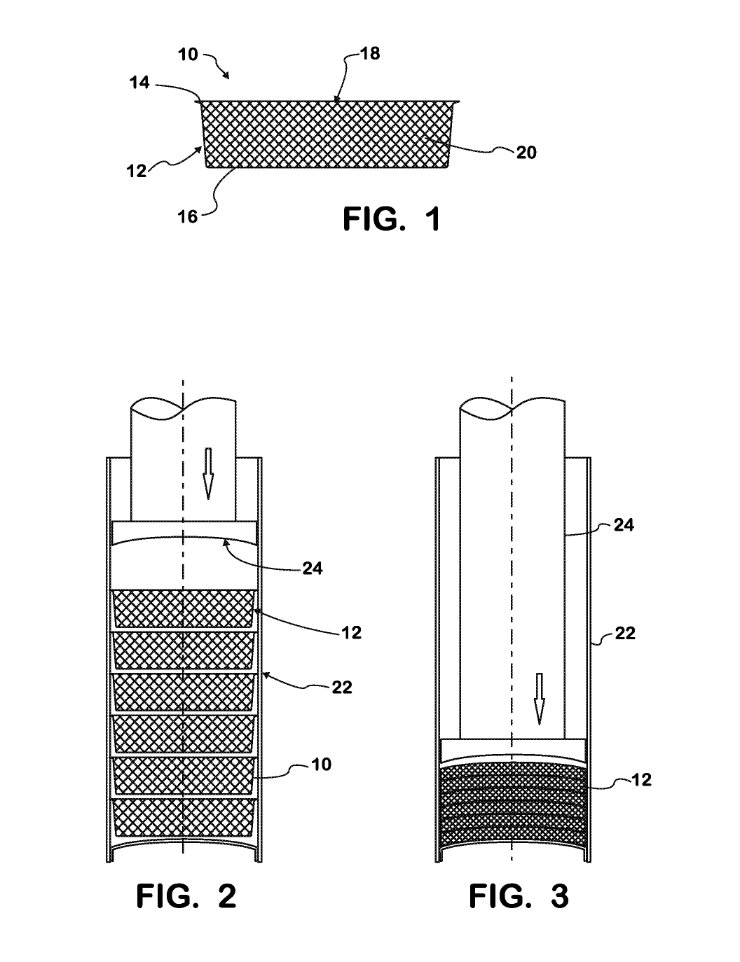

Referring to FIGS. 1-3, there is illustrated a device and method for storage and delivery of ammonia for use on a vehicle, and in particular, in the reduction of NOₓ in the exhaust system of a vehicle (not shown). As the exhaust system of a vehicle, including a diesel engine, is well-know, it will not be described in detail. The device 10 includes a pre-formed, sealable container 12, which is filled with a predetermined amount of ammonia-containing material 20. The filled container 12 is then sealed prior to loading into a canister 22 for attachment to a vehicle (not shown), wherein the ammonia gas is subsequently released and used to treat NOₓ in the exhaust stream.

Referring to FIG. 1, the container 12 of the present device 10 maybe any suitable shape, including but not limited to, a “pie pan” or “tray” shape, for receiving the ammonia-containing material 20 of the present invention. Pan-shaped containers are typically easier to handle, store and transport than ball-shaped or rounded containers. In addition, as will be described, the pan-shaped containers are easily stackable one on top of the other, for loading into a cartridge or canister 22, which is subsequently attached onto a vehicle.

As shown in FIG. 1, the container 12 includes a top edge 14 and a flat bottom 16. The container 12 can be constructed from any suitable material that is sturdy for loading and transporting the ammonia-delivery material 20, but yet compressible and crushable for stacking into the canister 22. In addition, the container material should ideally conduct heat, because it is through heating that the ammonia-delivery material 20 sublimates to release the ammonia gas. Aluminum sheets are suitable materials for use in constructing the container 12 of the present invention, and can be provided or molded into appropriate shapes for use as the container. Aluminum has a low mass density and excellent thermal conductivity and is thus preferred for construction of the present container 12.

The container 12 is easily sealable using known methods. A cover 18 is provided for engaging the top edge 14 of the container 12. In one embodiment, the cover 18 can be crimped to the top edge 14 of the container in such a manner that it forms a flat surface, either flush with or slightly below, the top of the container. The flat surface created by the cover 18 facilitates later stacking the filled containers one of top of the other. Filling the container 12 and attaching the cover 18 can be accomplished by methods that are known in the art, for instance, by using automated fill and seal packaging methods used in the food industry. The cover 18 should also be made of a material that is compressible, crushable and easily transfers heat. In one embodiment, the cover 18 may be made from a foil sheet having a suitable thickness.

Ammonia-delivery material 20 useful in the present device 10 can include many types of storage materials capable of releasing ammonia through thermal desorption. Suitable ammonia-delivery material 20 include metal-ammine salts, which offer a solid storage medium for ammonia, and represent a safe, practical and compact option for storage and transportation of ammonia. Ammonia may be released from the metal ammine salt by heating the salt to temperatures in the range from 10° C. to the melting point of the metal ammine salt complex, for example, to a temperature from 30° to 700° C., and preferably to a temperature of from 100° to 500° C. Generally speaking, metal ammine salts useful in the present invention include the general formula M(NH₃)ₙX_{z}, where M is one or more metal ions capable of binding ammonia, such as Li, Mg, Ca, Sr, V, Cr, Mn, Fe, Co, Ni, Cu, Zn, etc., n is the coordination number usually 2-12, and X is one or more anions, depending on the valence of M, where representative examples of X are F, Cl, Br, I, SO₄, MoO₄, PO₄, etc. Preferably, ammonia saturated strontium chloride, Sr(NH₃)Cl₂, is used in the container 12 of the present device 10. The container 12 is filled with an appropriate ammonia-delivery material 20 having a density of between about 0.4-0.6 g/cc.

As shown in FIG. 2, once the aluminum containers 12 are filled with the appropriate amount of ammonia-delivery material 20, and sealed with the cover 18, the containers are ready to be loaded into a canister 22. The filled canisters 22 are subsequently loaded into a proper containment and secured onto a vehicle. As mentioned, the canister 22 can be constructed of any suitable metal material, for durability and heat conductivity, including porous or dense aluminum, titanium, stainless steel or similar ammonia resistant metals or alloys. Groups of filled, sealed containers 12 would be automatically loaded into the canister 22 in a known manner. A ram 24 or another suitable form of compression device, exerts downward pressure on the stacked, sealed containers 12, pressing them to the bottom of the canister 22 using an appropriate amount of pressure, and compressing the density of the containers to about 1.2 g/cc, and also crushing the aluminum container in the process (FIG. 3). This cycle, of loading and compressing the filled containers 12 into the canister 22, may be repeated 3-4 times or until the canister is full of compressed materials, which would equally approximately 25-30 containers. Crushing the containers 12 within the canister 22 provides not only a desired amount of compacted ammonia-delivery material 20 within the canister, but also provides for excellent wall contact between the ammonia-delivery material and the canister wall for effective heat transfer. Once the canister 22 is filled with the desired amount of compressed containers 12, the canister is ready to be loaded onto or secured to a vehicle in a suitable manner.

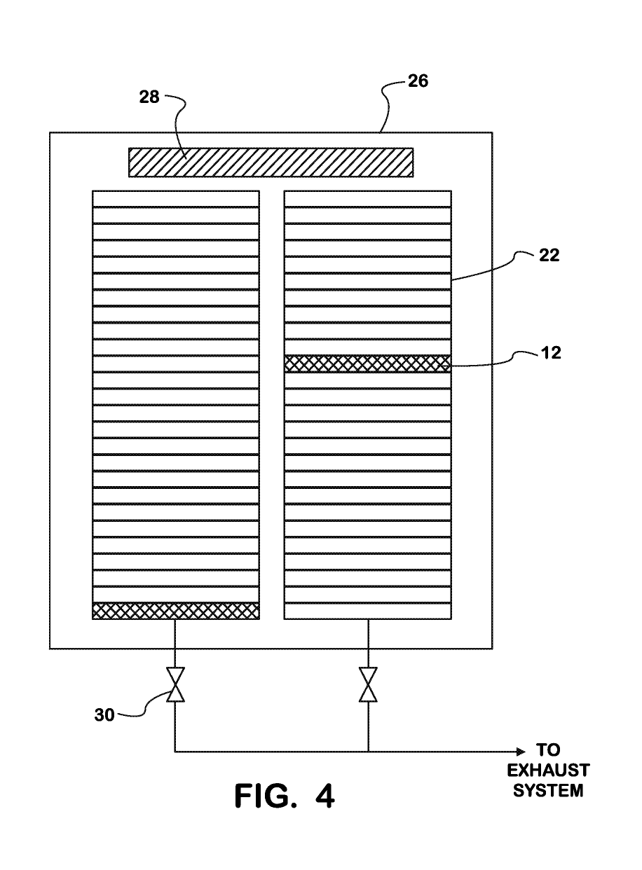

As illustrated in FIG. 4, in use, the secured, full canisters 22 would likely be received into a suitable containment unit or chamber 26 for securing onto a vehicle. In one embodiment, in order to release the ammonia gas for use in the reduction of NOₓ in an exhaust stream of a vehicle, heat is applied to the canister 22. Heat may be applied from a heating element 28 from a variety of sources, including but not limited to, an electrical resistive device, or hot exhaust gases from a combustion process. The heat would then transfer through the canister 22 to the crushed, compacted aluminum containers 12 situated within the canister 22. The aluminum container 12 would likewise conduct heat to the ammonia saturated strontium chloride 20 within the containers 12, releasing ammonia in a gaseous form into the canister 22. As shown in FIG. 4, in some embodiments, a controllable dosing valve 30 may be used to control the release of ammonia within the canister 22 to be used in the catalytic reduction of NOₓ in a vehicle exhaust system (not shown).

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A device for storage and delivery of ammonia, the device comprising:
a pre-formed, sealable container; and, a predetermined amount of a solid ammonia-containing material, wherein the container is filled with the ammonia-containing material prior to sealing.

2. The device of claim 1, wherein the container comprises a top edge, a flat bottom, and a cover for sealing with the top edge of the container.

3. The device of claim 1, wherein the container comprises a compactable material.

4. The device of claim 1, wherein the container comprises a heat transfer material.

5. The device of claim 4, wherein the container comprises a pre-formed aluminum sheet.

6. The device of claim 2, wherein the cover comprises a thin metal sheet.

7. The device of claim 1, wherein the ammonia-delivery material comprises a metal-ammine salt.

8. The device of claim 7, wherein the metal-ammine salt comprises strontium chloride.

9. The device of claim 1, wherein the ammonia-delivery material has a density of between about 0.4 g/cc and 0.6 g/cc.

10. A device for storage and delivery of ammonia for use on a vehicle, the device comprising:
a sealable container comprising a heat transfer material;
a predetermined amount of a solid ammonia-containing material, wherein the container is filled with the ammonia-containing material prior to sealing; and,
a canister for receiving the filled, sealed containers.

11. The device of claim 10, wherein the container includes a top edge, a flat bottom, and a cover for sealing with the top edge of the container.

12. The device of claim 10, wherein the container comprises a compactable material.

13. The device of claim 12, wherein the container comprises a pre-formed aluminum sheet.

14. The device of claim 11, wherein the cover comprises a thin metal sheet.

15. The device of claim 10, wherein the ammonia-delivery material comprises a metal-ammine salt.

16. The device of claim 15, wherein the metal-ammine salt comprises strontium chloride.

17. The device of claim 10, wherein the ammonia-delivery material has a density of about 0.4 g/cc.

18. A method for storage and delivery of ammonia on a vehicle, the method comprising the steps of:
providing a container comprising a heat transfer material, the container including a top edge, a flat bottom, and a cover for sealing the top edge of the container;
providing a predetermined amount of solid ammonia-containing material;
filling the container with the predetermined amount of the ammonia-containing material; and,
sealing the top edge of the container after filling with the ammonia-delivery material forming a stackable container.

19. The method of claim 18, wherein the container comprises a compactable material.

20. The method of claim 19, wherein the container comprises a pre-formed aluminum sheet.

21. The method of claim 18, wherein the step of sealing the cover of the container includes crimping the cover to the top edge.

22. The method of claim 18, wherein the method further comprises the step of loading a canister by stacking a plurality of the filled, sealed containers one on top of the other within the canister.

23. The method of claim 22, wherein the method further comprises the step of compressing the stacked containers within the canister.

24. The method of claim 23, wherein the method further includes crushing the filled containers within the canister after compression for subsequent release of the ammonia.

25. The method of claim 23, wherein the containers are compressed to a density of about 1.2 g/cc.
